(19) United States
(12) Patent Application Publication
(10) Pub. No.: US 2007/0075196 A1
(43) Pub. Date: Apr. 5, 2007

(54) Apparatus holder suction base with cylinder-piston structure

(76) Inventor: Harald Richter, Engelsbrand (DE)

Correspondence Address: Klaus Bach, 4407 Twin Oaks Dr, Murrysville, PA, 15668, US

(21) Appl. No.: 11/344,723

(22) Filed: Jan. 31, 2006

(30) Foreign Application Priority Data
Sep. 30, 2005 (DE) 10 2005 046 869.1

(51) Int. Cl. F16B 47/00; A45D 42/14

(52) U.S. Cl. 248/205.8; 248/363

(57) ABSTRACT

In a suction base for an apparatus holder comprising a housing with an opening formed by a lower wall edge of the housing and a cylindrical wall forming a cylindrical cavity in the housing, a piston, sealed against the cylindrical wall, is axially movably supported in the housing and an operating mechanism is provided on the housing and connected to the piston via an opening of the housing for moving the piston out of a release position adjacent the lower edge of the housing into the cylindrical cavity so as to generate a vacuum between the piston and a support surface on which the suction base is disposed in order to firmly retain the suction base on a support surface.

### BACKGROUND OF THE INVENTION

The invention relates to a suction base for holders of apparatus such as minicomputers called PDA's, mobile navigation apparatus, mobile telephone, etc.

Such apparatus holders are known for example from DE 103 11 112 A1. They permit the rapid attachment of the holders to smooth surfaces such as windshields, dashboards or flat, smooth support plates mounted to other support structures.

The suction bases known include a flexible suction membrane which forms the bottom of a bell housing and at the center of which a rod is mounted which is coupled to an operating lever for pulling the suction membrane from a flat release position into the housing to a suction position in which a vacuum is generated between the membrane and the smooth mounting surface by which the suction base is firmly held in engagement with the mounting surface.

Since the suction membrane must be movable, the housing bell cannot be connected to the membrane. Although in the operating position of the suction membrane, the housing bell is biased by the holding force into contact with the edge of the suction membrane the total engagement force must be taken up by the suction membrane in the form of a pulling force. When subjected to excessive heat for example upon exposure to the sun rays as it is unavoidable when such a suction base is attached to a vehicle windshield, the softener compounds are degassed from the compounds of which the membrane consists with the result that the membrane sticks to the edge of the bell housing which results in disturbances and a slow embrittlement of the membrane.

It is the object of the present invention to provide an apparatus holder suction base without the problems just mentioned.

### SUMMARY OF THE INVENTION

In a suction base for an apparatus holder comprising a housing with an opening formed by a lower wall edge of the housing and a cylindrical wall forming a cylindrical cavity in the housing, a piston, sealed against the cylindrical wall, is axially movably supported in the housing and an operating mechanism is provided on the housing and connected to the piston via an opening of the housing for moving the piston out of a release position adjacent the lower edge of the housing into the cylindrical cavity so as to generate a vacuum between the piston and a support surface on which the suction base is disposed in order to firmly retain the suction base on a support surface.

This arrangement has the advantage over the membrane that not only the center area is pulled in for generating the vacuum whereby a flat cone is formed by the membrane, but a rather low pressure volume is generated by the movement of the piston which extends fully over the whole cross-sectional area of the piston. As a result, such a suction base can be smaller in diameter than conventional membrane suction bases while providing the same retaining force. In addition the suction base is supported on the support surface in a firmer and more stable manner since the retaining forces are transmitted via the suction base edge directly to the support surface.

The invention will become more readily apparent from the following description of a number of embodiments thereof on the basis of the accompanying drawings.

### BRIEF DESCRIPTION OF THE DRAWINGS

FIGS. 1 and 2 show in a cross-sectional view a suction base according to the invention in a release position and, respectively, a suction position.

FIGS. 3-6 show an arrangement as shown in FIGS. 1 and 2, but with different operating mechanisms, and

FIGS. 7-10 show arrangements with different sealing structures for the sealing engagement of the base with a support surface.

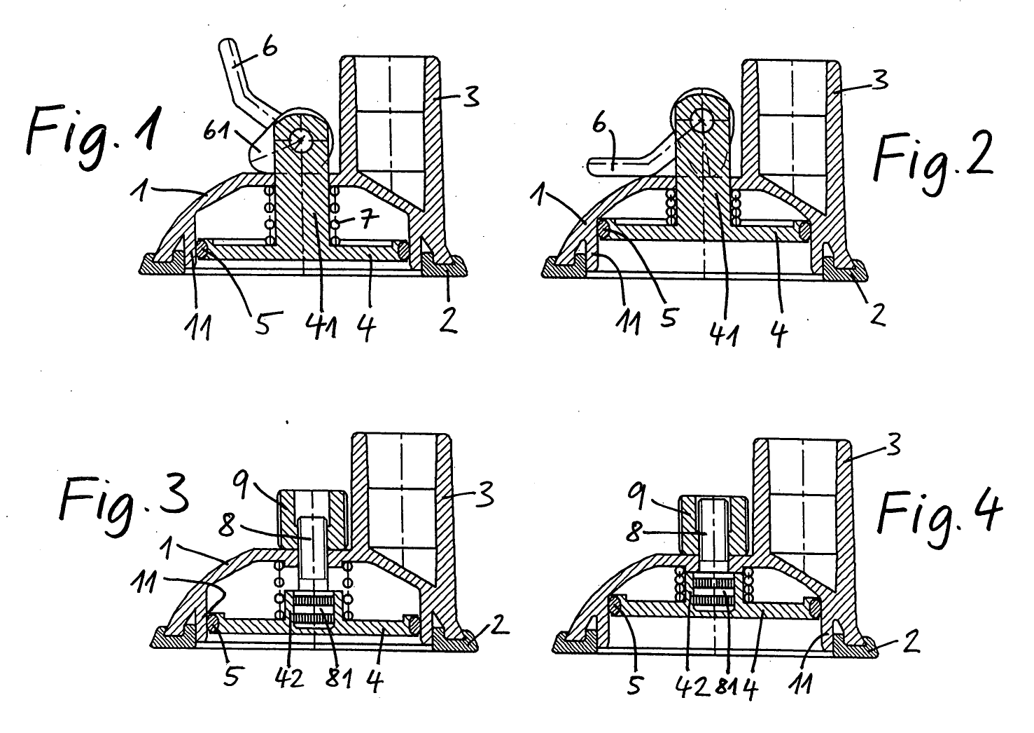

DESCRIPTION OF THE VARIOUS EMBODIMENTS FIGS. 1 and 2 show a first embodiment of an apparatus holder suction base in cross-section in a release position (FIG. 1) and in an operating suction position (FIG. 2). The cross-sectional view reveals the base arrangement of the suction base according to the invention.

The suction base comprises a housing 1, which is open at the bottom end thereof. The lower circumferential edge of the housing 1, by which the housing is to be supported on a support surface is provided with a circumferential seal 2 of a rubber material or a soft plastic. The housing has a cylindrical wall 11, which forms a downwardly open cylinder of short axial length. The housing 1 is further provided with a connecting part 3, which in the example shown is a tubular projection for the support of for example a flexible arm, that is, a so-called goose neck, a column, a joint or another component of a support structure. The connecting part 3 of course is not part of the invention and could be in any form or shape as required by the component to be connected to the housing 1. Also, a connecting part for the support of another component of the apparatus holder such as a column may be formed integrally with the base housing 1.

Within the cylinder space surrounded by the cylinder wall 11, a piston 4 is axially slidably supported. It is provided at its circumference with a seal 5 that sealingly engages the inner surface of the cylinder wall 11. The piston 4 is carries at its center a piston rod 41, which extends upwardly through a corresponding opening in the housing 1. At its end outside the housing 1, an operating lever 6 is connected to the piston rod 41 and the operating lever 6 has a cam 61 via which it is supported on the top surface of the housing 1. A compression spring 7 is disposed between the piston 4 and the upper housing wall around the piston rod 41 such that the piston 4 is biased by the spring 7 into its release position as shown in FIG. 1.

If the operating lever 6, which in the exemplary embodiment of FIG. 1 extends upwardly when the piston is in the release position, is pivoted downwardly, the cam 61 is also moved downwardly and caused the piston rod 41 to be pulled out of the housing 4 against the force of the compression spring 7 resulting in an upward movement of the piston 4 in the cylinder space surrounded by the cylinder wall 11. As a result, the volume within the cylinder wall 11, that is, in the lower area of the housing 1 between the support surface and the piston 4 is increased so that a vacuum with a corresponding holding force is generated whereby the suction base is firmly biased via its circumferential seal 1 against the support surface.

Of course, instead of a piston rod 41 as shown in FIG. 1 another component may be connected to the piston 4 for pulling the piston 4 into the housing 1 and, instead of the operating lever 6, another operating structure may be used for moving the piston from its release position (FIG. 1) to its operating position as shown in FIG. 2.

The housing 1, the piston 4 and the operating lever, all consist preferably of plastic material and are formed by injection molding.

FIGS. 3 and 4 show an embodiment of the apparatus holder suction base wherein the piston rod 4 of FIGS. 1 and 2 is replaced by a threaded rod 8, preferably in the form of a separate metallic component. The rod 8 however is firmly connected to the piston 4 via a sleeve 42, which is integrally formed with the piston 4. The threaded rod 8 has a bottom end section 81 which is firmly engaged in the sleeve 42 during the injection molding procedure. The threaded rod 8 extends upwardly through the housing opening and the projection end is provided for example with a rotatable operating wheel 9 which has a corresponding internal thread. By rotating the operating wheel 9, the threaded shaft 8 with the piston 4 attached thereto can be axially moved. Since the piston 4 is in frictional contact with the cylinder wall 11 by the seal 5 disposed at the circumference of the piston, the piston will not be rotated by the rotation of the operating wheel 9.

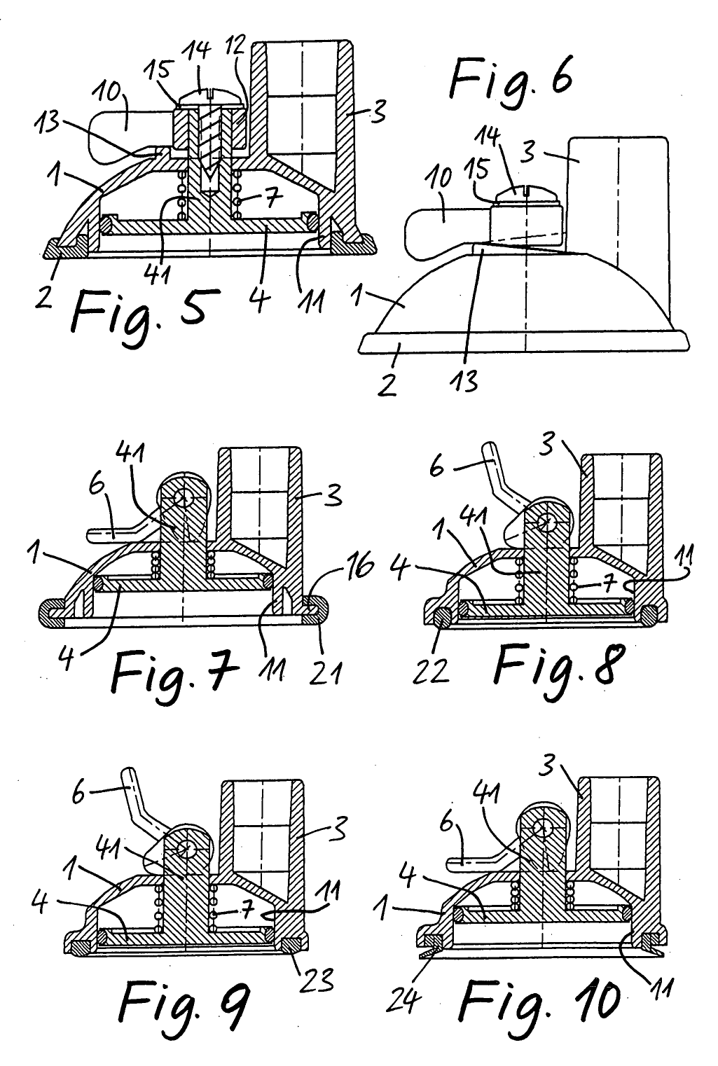

FIGS. 5 and 6 show another operating mechanism for the piston 4. Again a rotatable operating element is provided, here however in the form of a radially projecting rotating lever 10 which has a sleeve hub 2. The piston 4 is again provided with a piston rod 41 which is integrally formed with the piston but which has a central opening into which a screw 44 is threaded. A washer 45 is disposed on the top surface of the sleeve hub 12 and held in firm engagement with the piston rod 41. The lever 10 is rotatably supported on the piston shaft 41 and supported on the housing 1 via an annular cam 13 formed on the top surface of the housing 1, so that, upon rotation of the lever 10, the lever with the sleeve hub 12 is raised or lowered while sliding along the annular cam 13. The annular cam 13 is clearly visible in the side view of FIG. 6. If, in the shown embodiment, the lever 10 is rotated clockwise it is raised while sliding along the cam 13 and, via the washer 15 and the screw 14, raises the piston rod 4 and, together therewith, the piston 4 to move it to its operating position.

FIGS. 7-10 show various embodiments concerning the seal at the bottom edge of the housing 1.

Whereas in the earlier described embodiment, the annular seal 2 at the lower edge of the housing is provided with an axial groove in which an outer circumferential leg of the housing wall is received, the seal 21 of the embodiment as shown in FIG. 7 has a radial groove in which a radially outwardly projecting flange 16 formed at the bottom end of the housing 1 is received.

In the embodiment as shown in FIG. 8, the housing edge is relatively wide and is provided with an annular groove in which a seal ring 22 is disposed, preferably in the form of an O-ring. But it may also have another shape such as a rectangular trapezoidal or other cross-section.

The embodiment shown in FIG. 9 is similar to that of FIG. 8. In the embodiment of FIG. 9, a seal ring 23 with a squared upper part which is received in a squared groove is shown. Preferably however the seal ring 23 has a curved lower face for sealing engagement with a support surface.

In the embodiment as shown in FIG. 10, a lip seal 24 is provided on the seal member 24. Such a seal structure has the advantage that it can adapt to a slight curvature of the support surface as it is present for example in windshields of motor vehicles. The embodiment of FIG. 10 may also be varied so that the seal 24 has an x-shaped cross-section. Other embodiments for seals at the lower edge of the housing are of course possible; the embodiments shown only serve to show the multitude of possibilities.

The suction base according to the invention can of course be used not only in connection with apparatus holders for mobile minicomputers, navigation apparatus, mobile telephones etc., in motor vehicles but the suction base may also be used for other applications wherein an apparatus or object has to be supported by a smooth surface to which it can be attached by suction.

In all embodiments of the suction base according to the invention, the shape of the housing 1 is not particularly important. The housing may be circular but the shape which is determined by the edge of the housing with the seal disposed along the edge may also be for example oval, or polygonal. It is only important that a cylinder wall 11 is formed in the housing 1 that is a cylindrical inner surface is provided with which the piston 4 can cooperate.

What is claimed is:

1. A suction base for an apparatus holder comprising a housing (1) which is open at a lower end thereof and has a lower circumferential edge provided with a housing seal member (2) said housing (1) including a cylindrical wall (11) defining a cylindrical space, a piston (4) movably disposed in the cylindrical space and including a seal (5) in sealing contact with the cylindrical wall (11), and an operating mechanism for moving the piston (4) in the cylindrical space, the operating mechanism comprising a shaft (41, 5) extending from the piston (4) through the housing wall (11) and an operating element (6, 9, 10) for axially moving the shaft (41, 5) and, together therewith, the piston (4) between a release position and an operating position, in which the piston (4) is retracted into the cylindrical space of the housing (1).

2. A suction base according to claim 1, wherein the operating mechanism comprises an operating lever (6) pivotally supported on the shaft (41) and having a cam (61) in contact with the housing (1) so that, upon pivoting of the lever (6), the shaft (41) and, together therewith, the piston (4) is raised and pulled into the housing (1).

3. A suction base according to claim 1, wherein the operating mechanism comprises a threaded shaft (8) extending from the piston (4) through the housing (1) with an operating wheel (9) threaded onto the shaft and seated on the housing (1) so that, by rotation of the threaded wheel (9) the shaft (8) and, together therewith, the piston (4) is raised and pulled into the housing (1).

4. A suction base according to claim 1, wherein the operating mechanism comprises a shaft (41) extending from the piston (4) through the housing (1) with a lever (10) supported on the shaft (41) so as to be pivotable about the shaft axis, said housing being provided with a ramp (13) extending on the housing (1) around shaft (41) so that, by rotating said lever (10), which is seated on said ramp (13), said lever (10) and, together therewith, said shaft (41) and said piston (4) are raised and the piston (4) is pulled into the housing (1).

5. A suction base according to claim 1, wherein said piston (4) is provided at its circumference with a seal ring (5) for sealing the piston (4) with respect to the cylindrical wall (11).

6. A suction base according to claim 4, wherein the cylindrical wall (11) is formed by a cylindrical structure disposed radially inwardly of the housing seal member (2).

7. A suction base according to claim 1, wherein the housing (1) has at its open end an outwardly extending flange and the housing seal member 2 has a radially inner annular groove receiving the outwardly extending flange.

8. A suction base according to claim 1, wherein the housing (1) has at its open lower and a downwardly open annular groove in which a seal ring (22) is disposed.

9. A suction base according to claim 8, wherein the seal ring (27) is an O-ring.

10. A suction base according to claim 8, wherein the downwardly open annular groove has a squared cross-section and an annular seal member with a squared cross-section is disposed in the annular groove of the housing (1).

11. A suction base according to claim 10, wherein the annular seal member includes a lip seal structure (24).

12. A suction base according to claim 1, wherein a compression spring (7) is disposed between the housing (1) and the piston (4) for biasing the piston (4) into its release position.
